(19) United States
(12) Patent Application Publication
(10) Pub. No.: US 2026/0162018 A1
(43) Pub. Date: Jun. 11, 2026

(54) Training Machine Learning Models to Provide Positional Outputs Relative to Inputs

(71) Applicant: GDM Holding LLC, Mountain View, CA (US)

(72) Inventors: Antoine Miech, Paris (FR); Kanav Garg, San Francisco, CA (US); Geoffrey Edward Brown, New York, NY (US); Miteyan Bhavesh Patel, London (GB)

(21) Appl. No.: 19/417,206

(22) Filed: Dec. 11, 2025

Related U.S. Application Data
(60) Provisional application No. 63/730,821, filed on Dec. 11, 2024.

(51) Int. Cl. G06N 20/00; G06F 3/0482

(52) U.S. Cl. CPC G06N 20/00; G06F 3/0482

(57) ABSTRACT

Provided are systems and methods for training machine learning models to process various types of inputs and provide a positional output relative to the input. In particular, the systems and methods of the present disclosure can enhance a model's ability to interpret and interact with inputs based on positional data rather than relying solely on predefined identifiers. This generalized approach is applicable to a range of inputs, including but not limited to user interfaces.

### RELATED APPLICATIONS

This application claims priority to and the benefit of U.S. Provisional Patent Application No. 63/730,821, filed Dec. 11, 2024, and titled “Training Machine Learning Models to Provide Positional Outputs Relative to Inputs”. U.S. Provisional Patent Application No. 63/730,821 is hereby incorporated by reference in its entirety.

### FIELD

The present disclosure relates generally to machine learning processes and machine-learned devices and systems. More particularly, the present disclosure relates to systems and methods which train and then leverage machine learning models to provide positional outputs relative to inputs.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method. The computer-implemented method includes obtaining, by a computing system which may include one or more computing devices, a training example which may include a training input and a target output. The method also includes where the training input may include a plurality of identifiers that respectively correspond to a plurality of items. The method also includes where the target output may include one or more of the plurality of identifiers. The method also includes modifying, by the computing system, the training example to obtain a modified training example. The method also includes where modifying the training example may include respectively replacing, in at least the target output, the one or more of the plurality of identifiers contained in the target output with one or more sets of positional data that respectively provide positional information for the one or more items to which the one or more of the plurality of identifiers contained in the target output correspond. The method also includes training, by the computing system, a machine learning model on the modified training example. Other embodiments of this aspect include corresponding computer systems, apparatus, and computer programs recorded on one or more computer storage devices, each configured to perform the actions of the methods.

Example implementations may include any combination of one or more of the following features. The computer-implemented method where obtaining the training example may include: processing an initial input to generate the plurality of identifiers; and annotating the initial input with the plurality of identifiers to generate the training input. The plurality of items may include a plurality of user interface elements contained in a user interface. The target output may include an action output that selects for interaction one or more of the user interface elements. The plurality of identifiers may have been generated by parsing a document object model (DOM) tree for the user interface. The training input may include textual content, and where the plurality of identifiers are embedded within the textual content. The training input may include image content, and where the plurality of identifiers are embedded within the image content. Modifying the training example may include respectively replacing, in both the training input and the target output, the plurality of identifiers with a plurality of sets of positional data that respectively provide positional information for the plurality of items to which the plurality of identifiers correspond. Modifying the training example may include respectively removing, from the training input, the one or more of the plurality of identifiers that are contained in the target output. Modifying the training example may include respectively removing, from the training input, only the one or more of the plurality of identifiers that are contained in the target output while leaving the other identifiers within the training input. The one or more sets of positional data may include one or more sets of two-dimensional coordinates. The one or more sets of two-dimensional coordinates may include center points of one or more bounding boxes associated with the one or more items to which the one or more of the plurality of identifiers contained in the target output correspond. The machine learning model may include a sequence processing model. Training the machine learning model on the modified training example may include performing supervised finetuning with the machine learning model on the modified training example. Training the machine learning model on the modified training example may include performing reinforcement learning with the machine learning model on the modified training example. Performing reinforcement learning with the machine learning model on the modified training example may include: processing the training input of the modified training example with the machine learning model to generate, as an output of the machine learning model, a predicted output; generating a reward value based on the predicted output; and modifying one or more values of one or more parameters of the machine learning model based on the reward value. The predicted output may include a predicted set of coordinates, and where generating the reward value may include: providing a positive reward value when the predicted set of coordinates is included within one or more bounding boxes associated with the one or more items to which the one or more of the plurality of identifiers contained in the target output correspond; and providing a negative reward value when the predicted set of coordinates is not included within one or more bounding boxes associated with the one or more items to which the one or more of the plurality of identifiers contained in the target output correspond. Training the machine learning model on the modified training example may include: determining that the one or more items to which the one or more of the plurality of identifiers contained in the target output correspond were not correctly parsed into the training input; and in response to determining that the one or more items to which the one or more of the plurality of identifiers contained in the target output correspond were not correctly parsed into the training input, training the machine learning model on the modified training example. The method may include, prior to training, by the computing system, the machine learning model on the modified training example: training, by the computing system, the machine learning model on a set of training data may include training inputs and training outputs that contain positional data for items exclusive of item identifiers. The predicted output may include a predicted set of coordinates, and where the reward value is, at least in some cases, inversely proportional to a distance between the predicted set of coordinates and at least one of the one or more sets of positional data. Modifying the training example may include respectively removing, from the training input, all of the plurality of identifiers. Implementations of the described techniques may include hardware, a method or process, or computer software on a computer-accessible medium.

One general aspect includes a computer-implemented method. The computer implemented method may include generating, by a computing system which may include one or more computing devices, a set-of-marks-based training dataset. Generating the set-of-marks-based training dataset may include, for each of a number of training inputs: generating a plurality of identifiers respectively for a plurality of items included in the training input; annotating the training input to include the plurality of identifiers; processing the annotated training input with a machine-learned model to generate, as an output of the machine-learned model a model-generated output, where the model-generated output may include one or more of the plurality of identifiers; storing the model-generated output as a target output for the training input to generate a training example. The method also includes modifying, by the computing system, the training example to obtain a modified training example. The method also includes where modifying the training example may include respectively replacing, in at least the target output, the one or more of the plurality of identifiers contained in the target output with one or more sets of positional data that respectively provide positional information for the one or more items to which the one or more of the plurality of identifiers contained in the target output correspond. The method also includes training, by the computing system, a machine learning model on the modified training example. Other embodiments of this aspect include corresponding computer systems, apparatus, and computer programs recorded on one or more computer storage devices, each configured to perform the actions of the methods.

Example implementations may include any combination of one or more of the following features. The computer-implemented method where the machine learning model is the same as the machine-learned model. The computer-implemented method may include, prior to training, by the computing system, the machine learning model on the modified training example: training, by the computing system, the machine learning model on a set of training data may include training inputs and training outputs that contain positional data for items exclusive of item identifiers. Implementations of the described techniques may include hardware, a method or process, or computer software on a computer-accessible medium.

One general aspect includes a computer-implemented method. The computer implemented method includes obtaining, by a computing system which may include one or more computing devices, user interface data descriptive of a user interface. The method also includes processing, by the computing system, the user interface data to generate a plurality of identifiers respectively for a plurality of items contained in the user interface. The method also includes generating, by the computing system, a model input containing a representation of the user interface that has been annotated with the plurality of identifiers. The method also includes processing, by the computing system, the model input with a machine-learned model to generate a model output, where the model output may include one of the plurality of identifiers or a predicted set of coordinates. Other embodiments of this aspect include corresponding computer systems, apparatus, and computer programs recorded on one or more computer storage devices, each configured to perform the actions of the methods.

A computing system may be configured to perform the methods described herein. One or more non-transitory computer-readable media may collectively store computer-executable instructions for performing the methods described herein. One or more non-transitory computer-readable media may collectively store a machine-learned model that has been trained by performance of the methods described herein.

### BRIEF DESCRIPTION OF THE DRAWINGS

FIG. 1 is a block diagram illustrating a system for modifying a training example to include positional data and training a machine learning model with the modified training example according to example implementations of aspects of the present disclosure.

FIG. 2 is a block diagram depicting the generation of a set-of-marks-based training dataset for subsequent modification to include positional data for training a machine learning model according to example implementations of aspects of the present disclosure.

FIG. 3 is a block diagram showing a process for generating a model output that includes identifiers and/or positional data from user interface data, using a machine-learned model according to example implementations of aspects of the present disclosure.

FIG. 4 is a block diagram illustrating a simplified process for directly generating a model output that includes positional data from user interface data, using a machine-learned model according to example implementations of aspects of the present disclosure.

FIG. 5 is a flow chart diagram illustrating an example method for training a machine-learned model according to example implementations of aspects of the present disclosure;

FIG. 6 is a block diagram of an example processing flow for using machine-learned model(s) to process input(s) to generate output(s) according to example implementations of aspects of the present disclosure;

FIG. 7 is a block diagram of an example sequence processing model according to example implementations of aspects of the present disclosure;

FIG. 8 is a block diagram of an example technique for populating an example input sequence for processing by a sequence processing model according to example implementations of aspects of the present disclosure;

FIG. 9 is a block diagram of an example model development platform according to example implementations of aspects of the present disclosure;

FIG. 10 is a block diagram of an example training workflow for training a machine-learned model according to example implementations of aspects of the present disclosure;

FIG. 11 is a block diagram of an inference system for operating one or more machine-learned model(s) to perform inference according to example implementations of aspects of the present disclosure;

FIG. 12 is a block diagram of an example networked computing system according to example implementations of aspects of the present disclosure;

FIG. 13 is a block diagram of an example computing device according to example implementations of aspects of the present disclosure; and

FIG. 14 is a block diagram of an example computing device according to example implementations of aspects of the present disclosure.

### DETAILED DESCRIPTION

Example aspects of the present disclosure are directed to systems and methods for training machine learning models to process various types of inputs and provide a positional output relative to the input. In particular, the systems and methods of the present disclosure can enhance a model's ability to interpret and interact with inputs based on positional data rather than relying on predefined identifiers. This generalized approach is applicable to a range of inputs, including but not limited to user interfaces.

In particular, in some alternative approaches, models are provided with an input that utilizes identifiers to identify specific items or elements within the input. These identifiers can be referred to as a “set of marks,” as they mark the items within the input and give the model a specific identifier by which to refer to a particular item (e.g., within the model's output). However, this set-of-marks-based representation can pose limitations when identifiers are inaccurately parsed, missing, and/or when items are dynamically altered, leading to a decrease in model performance and adaptability.

In view of the above challenges, example systems and methods described herein can improve the flexibility of machine learning models by enabling the models to interpret inputs and generate outputs based on positional information, rather than specific identifiers such as a set of marks. For instance, one example technique described herein can include modifying training examples that were originally annotated with identifiers, by replacing these identifiers (e.g., in the training input and/or the target output) with sets of positional data, such as two-dimensional coordinates. This conversion of the training data from a set-of-marks-based representation to a position-based representation allows the model to learn to directly predict the position of items, independent of specific identifiers.

By adopting the proposed techniques, machine learning models can be trained to maintain high functionality and accuracy across diverse scenarios where conventional identifier-based methods may wholly or partially fail. This leads to broader applicability and robustness in real-world applications where input elements may not always conform to predictable or static identifier schemes.

More particularly, one example aspect of the present disclosure is directed to a computer-implemented method that can enhance the training of machine learning models by modifying training examples to focus on positional data rather than set-of-marks-based identifiers. Initially, a computing system can obtain a training example that includes a training input and a target output. The training input can contain a plurality of identifiers, each corresponding to specific items within the input. Similarly, the target output includes one or more of these identifiers. The method then includes modifying the training example by replacing the identifiers (e.g., in the training input and/or in the target output) with sets of positional data. This positional data provides specific location information for the items associated with the replaced identifiers. For example, if the original identifier corresponds to a button on a user interface, the positional data might include x and y coordinates that correspond to the button's location (e.g., center point) on the screen. Following this modification, the computing system can train a machine learning model on the modified training example, enabling the model to learn to recognize and interact with items based on their spatial properties rather than relying solely on identifiers. For example, the model can learn to generate an output that identifies the x and y coordinates of the button for interaction (e.g., a “click” interaction).

In some implementations, obtaining the training example can include generating the training example. For example, the generation process can begin with processing an initial input to generate a plurality of identifiers. Each identifier can correspond to distinct items present within the input. For instance, in the context of a user interface, these identifiers might be associated with various interactive elements like buttons, text fields, or images. Following the generation of these identifiers, the initial input can be annotated with these identifiers to create the training input. For example, this annotation can embed the identifiers within the input in a manner that maintains their association with the respective items. The training example can then be modified, as described above.

As noted above, the plurality of items referred to in the training examples include a plurality of user interface elements contained within a user interface. These user interface elements can include, for example, buttons, links, input fields, dropdown menus, and/or other interactive components that are commonly found in digital interfaces. By training a model to interact with user interface elements, the model can learn to interact with and navigate through software applications, websites, and/or other interactive interfaces. Further, by learning to recognize and respond to these elements, the model can effectively perform tasks such as automating user actions, testing software, or enhancing user accessibility features.

In some implementations, the target output within the training example is an action output that selects for interaction one or more of the user interface elements. Thus, the output from the training process may dictate interactions with specific elements. For example, the action output might specify that a button should be clicked or that a text field should be filled. This capability is beneficial for applications where the machine learning model is expected to perform interactive tasks autonomously, such as in automated testing and/or navigation of software applications where simulating or effectuating user interactions with various interface elements is necessary.

In some implementations, the plurality of identifiers used in the training examples are generated by parsing a Document Object Model (DOM) tree of a user interface. The DOM tree is a structured representation of the user interface elements in a web page, which allows various programming languages to interact with the web page content. By parsing the DOM tree, the method can systematically extract identifiers corresponding to specific user interface elements such as buttons, text fields, and other interactive components. For instance, each element in the DOM tree can be assigned a unique identifier that the training process then utilizes to create the training input. Additionally or alternatively, techniques such as object detection, text parsing, semantic segmentation, semantic instance segmentation, and/or other techniques (e.g., processing the input with a large language model) can be performed to generate the identifiers.

In some implementations, the training input can include image content. The plurality of identifiers can be embedded within the image content. This arrangement is particularly useful for training machine learning models that are expected to interact with or analyze image-based interfaces (e.g., “screengrabs”) or other image content. For instance, identifiers could be embedded within graphical elements of a user interface, such as icons, buttons, or other visual indicators. As examples, the identifiers can include numerals, bounding shapes (e.g., bounding boxes), shading, colorization, visual patterns, and/or other visual markers. These identifiers can serve as reference points that the model uses to recognize and interact with specific elements within the image.

Alternatively or additionally to image content, in some implementations, the training input includes textual content. The identifiers can be embedded within the textual content. This configuration allows for the training of machine learning models that can process and interact with text-based interfaces or documents. For example, the identifiers might be embedded within HTML or XML code, or within the text of a software application's interface, labeling various textual elements such as headers, paragraphs, or interactive text links. Textual identifiers can include numerals, delimiters, markings, and/or other indicators of identity.

In some implementations, the modification of the training example includes replacing the plurality of identifiers with a plurality of sets of positional data in both the training input and the target output. This modification provides positional information for the plurality of items to which the identifiers correspond. For example, if the identifiers in a user interface training input refer to specific buttons or fields, these identifiers can be replaced with coordinates that specify the location of these elements within the interface. By doing so, the training process focuses on teaching the machine learning model to recognize and interact with items based on their spatial properties rather than relying on symbolic identifiers. The positional data can include various formats of positional information, including Euclidean coordinates, polar coordinates, ordering information, and/or other forms of identifying position. Positioning data can be one-dimensional, two-dimensional, three-dimensional, etc.

The positional data used to replace the identifiers can be obtained from a number of sources. As one example, the positional information can be obtained from the DOM tree of the corresponding web document. In particular, in some examples, some or all of the DOM elements on a webpage may have a function (e.g., the getClientRects( ) function) that outputs the coordinates of the bounding box of the item. This can be used as the ground truth and can be normalized (e.g., on a scale of 1 to 1000, as described further below) so that the computing system can operate on any resolution.

In some implementations to handle the variance in the size or resolution of web documents or other input data structures which contain items, each input (e.g., image input) can be normalized to have a pre-defined size. As another possibility, the positional data can be normalized rather than the input image. For example, the input image may have an arbitrary size but the positional data can be normalized. For example, coordinates can be normalized (e.g., on a scale of 1 to 1000, so an x coordinate of 500 means that it is exactly halfway between the left and right edge of the image).

As another example, lower-level representations in the rendering engine (or even the desktop user interface engine) can be used to generate the positional information for each item. As yet another example, the same or a different machine learning model (e.g., large multimodal model or vision-language model) can be used to obtain the positional data. For example, the identifier can be provided to the model for use in outputting the corresponding positional data. Another possible example is to use a specialized computer vision model to locate each item.

In some implementations, the positional data used to modify the training examples comprises one or more sets of two-dimensional coordinates. Specifically, these two-dimensional coordinates can include the center points of one or more bounding boxes associated with the items to which the identifiers in the target output correspond. For instance, if the item is a button on a user interface, the positional data might specify the central point coordinates of the bounding box that outlines this button. This approach allows the machine learning model to recognize and interact with items based on their spatial locations within an input, such as a graphical user interface or an image. Using the central points of bounding boxes is particularly beneficial as it provides a precise and standardized method for defining the position of items.

In some implementations, the modification of the training example includes various strategies for handling the identifiers embedded within the training input and/or target output. These modifications can adjust the amount and type of item representations available to the machine learning model during training. For instance, the method can include replacing both the identifiers in the training input and the target output with sets of positional data that provide specific location information for the items. Alternatively, the method can include removing some or all of the identifiers from the training input. This could mean removing only the identifiers that are also contained in the target output, while leaving other identifiers intact, or it could include removing all identifiers from the training input altogether.

These variations in the modification process train the model to comprehend inputs under different conditions: with no identifiers, with partial identifiers, or with full identifiers. This flexibility is beneficial for applications where the model needs to operate reliably regardless of the completeness of data in real-world scenarios. For example, in environments where some data might be missing or obscured, the model trained with these methods would still be able to function effectively by relying on whatever data is available, whether it be identifiers or positional information.

In some implementations, the machine learning model employed can be a sequence processing model, such as a Transformer model, for example. Sequence processing models are particularly adept at handling data that is sequential in nature, making them suitable for tasks including text, speech, or any form of data that unfolds over time or space. Sequence processing models are described in further detail with reference to the Figures. Example multimodal models include Gemini 1.5 (see, e.g., Gemini Team Google, et al., Gemini 1.5: Unlocking multimodal understanding across millions of tokens of context, arXiv:2403.05530 (2024)) and PaliGemma2 (see, e.g., Steiner, et al., PaliGemma 2: A Family of Versatile VLMs for Transfer, arXiv:2412.03555v1 (Dec. 4, 2024)).

In some implementations, training the machine learning model on the modified training example includes performing supervised finetuning with the machine learning model on the modified training example. Supervised finetuning is a method where the model is further trained on a specific dataset to refine its abilities to perform particular tasks, using known input-output pairs to adjust and optimize its parameters. For example, after initial training phases, the model can be finetuned with modified training examples that include positional data instead of identifiers.

In some implementations, training the machine learning model on the modified training example includes performing reinforcement learning with the machine learning model. Reinforcement learning is a type of machine learning where a model learns to make decisions by receiving feedback in the form of rewards or penalties. For instance, in the context of this method, the machine learning model processes the training input of the modified training example to generate a predicted output, which is then evaluated to generate a reward value. In some implementations, the reward value can be generated by a trained reward model (e.g., a model trained based on human preferences captured in reward model training data). In other implementations, the reward value can be generated procedurally, heuristically, and/or logically (e.g., via application of a pre-defined function or logic to produce a reward value based on the predicted output). In some cases where the reward value is machine-generated (e.g., generated procedurally, heuristically, and/or logically), the reinforcement learning can be referred to as reinforcement learning with machine feedback.

The generation of the reward value can be based on how accurately the predicted output matches the expected or “correct” outcome (e.g., as reflected by the target output). For example, if the predicted output comprises a set of coordinates, the reward value can be determined by whether these coordinates fall within the bounding boxes associated with the items identified in the target output. For example, a positive reward value can be provided if the predicted set of coordinates aligns with (e.g., is included within) the bounding box of an intended item, encouraging the model to repeat similar predictions in the future. Conversely, a negative reward value can be given if the predicted coordinates do not align (e.g., are outside of) the bounding box of the intended item, which discourages the model from repeating such predictions.

Additionally or alternatively, the reward value can be adjusted based on the proximity of the predicted set of coordinates to the target coordinates. For example, the reward value can be inversely proportional to the distance between the predicted coordinates and the actual position of the item, as defined by the positional data. Thus, larger distances may result in smaller (or negative) rewards; while smaller distances can result in larger (positive) rewards. As one example, the reward value can be inversely proportional to the distance between the predicted coordinates and the actual position of the item, irrespective of whether the predicted coordinates are contained within a bounding box of an intended item. In another example, the reward value can be inversely proportional to the distance between the predicted coordinates and the actual position of the item (but still remain positive) when the predicted coordinates are contained within a bounding box of an intended item, but may be zero or negative if the predicted coordinates are not contained within the bounding box of the intended item.

In some implementations, there may be an initial training phase that precedes the training on the modified training examples. During this preliminary stage, the computing system can train the machine learning model on a set of training data that exclusively contains positional data for items, without any accompanying item identifiers. This earlier training stage is beneficial as it equips the model with the ability to directly predict positional information from inputs that strictly provide spatial data about items. Stated differently, this initial exposure to positional data helps to ‘warm up’ the model, preparing it for subsequent training stages where it may encounter training examples that include both identifiers and positional data or lack identifiers altogether.

In some implementations, the original set-of-marks-based training dataset (prior to modification) can be generated by a computing system using an existing machine-learned model. This process can include generating a plurality of identifiers for various items included in each training input (e.g., via DOM parsing or other techniques as described herein). These identifiers are then used to annotate the training input (e.g., to create a set-of-marks-based input). Subsequently, this annotated training input is processed with a pre-trained machine-learned model, which generates an output comprising one or more of the identifiers. This output is then stored as the target output for the training input, thereby creating a set-of-marks-based training example. This set-of-marks-based training example can then be subject to the modification(s) as described herein. The machine learning model which is trained on the modified training examples can be the same as or different from the pre-trained machine-learned model that generated the target output. Thus, in some implementations, a pre-trained machine-learned model can be used to generate the set-of-marks-based target outputs. This is because a pre-trained machine-learned model may be able to perform reasonably well on this task, but may not be able to perform as well on the positional-based task (e.g., without further training). As such, unlabeled training data can be automatically-labelled using the pre-trained machine-learned model to generate set-of-marks-based target outputs. These outputs can then be modified as described herein to generate position-based training pairs and the same or different model can be trained on the position-based training pairs.

After training on the modified data, the trained model can be used for various tasks. As one example, the model can be utilized to process user interface data.

As one example, at inference-time when attempting to interact with a user interface, a computing system can obtain data descriptive of the user interface, which may include visual elements, interactive components, and other identifiable features of the interface. This data is then processed to generate a plurality of identifiers, each corresponding to different items contained within the user interface. Following the generation of identifiers, the computing system creates a model input that includes a representation of the user interface annotated with these identifiers. The model input is then processed with the trained model, which has been trained to recognize and interpret such annotated interfaces. The output from the machine-learned model can include either one of the generated identifiers or can include a predicted set of coordinates. This output can be used to direct interactions with the user interface.

As another, alternative example, at inference-time when attempting to interact with a user interface, a computing system can directly input the data descriptive of the user interface (e.g., without any identifiers) for processing with the trained model. The output from the machine-learned model can include a predicted set of coordinates. This output can be used to direct interactions with the user interface.

Another aspect of the present disclosure can improve the efficiency of models processing textual data in user interface (UI) action and screen understanding applications. In particular, standard tokenizers utilized in these models (e.g., which may include large language models, sequence processing models, etc.) may encounter challenges with HTML/DOM-heavy tasks due to suboptimal compression, which can lead to increased latency. This inefficiency primarily arises because HTML tags are infrequently encountered during the training of these tokenizers, resulting in their inadequate recognition as standard tokens.

To address this issue, some example implementations can incorporate HTML tags as user-defined tokens within the tokenizer's vocabulary. For example, HTML tags such as <a>, <html>, <body>, <img>, <span>, <bbox>, <ul>, <li>, <div>, <iframe>, <footer>, along with their respective closing tags, can be added as additional tokens. By integrating these tags directly into the tokenizer, the model can more readily recognize and process HTML/DOM-heavy content. This increased ability can reduce latency and improve the performance of UI-action and screen understanding tasks.

The systems and methods of the present disclosure provide a number of technical effects and benefits. As one example, the proposed technology significantly improves the accuracy and adaptability of machine learning models by enabling them to process and interpret user interfaces based on positional data, rather than solely relying on identifiers. This capability allows the models to function effectively even in scenarios where identifiers are missing or incorrectly parsed, which is a common issue in dynamic digital environments. By training the models to understand and utilize positional data, the technology addresses a technical problem inherent in the field of machine learning and user interface interaction.

As another example technical effect and benefit, the proposed techniques enable a machine learning model to predict positional data directly. This offers a significant technical benefit by obviating the need to generate set-of-marks during the inference phase. Traditionally, generating set-of-marks requires additional computational steps to identify and label elements within a user interface, consuming processing power and time. By training the model to use positional data instead, these steps are bypassed, leading to a reduction in the computational resources required at inference time. The ability to predict positional data directly from the input streamlines the workflow, reduces latency, and conserves energy, all of which are beneficial in deploying machine learning models, particularly in resource-constrained environments.

Various example implementations are described herein with respect to the accompanying Figures.

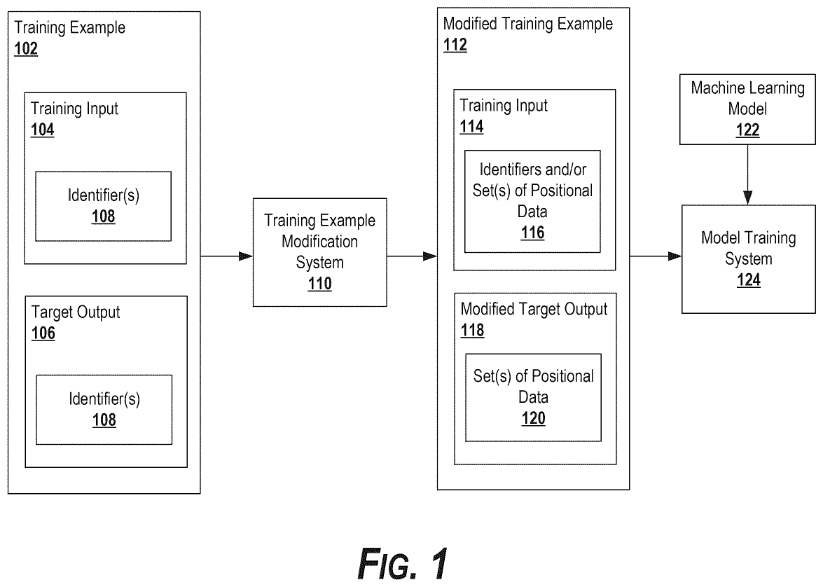

FIG. 1 is a block diagram illustrating an example system for modifying a training example to include positional data and subsequently training a machine learning model with the modified training example.

Training example 102 can be a data structure or any suitable format that includes a training input 104 and a target output 106. Training input 104 can include one or more identifiers 108, which can be labels, tags, or any form of metadata that correspond to specific items or features within the training input 104. Target output 106 also includes one or more identifiers 108, which can be similar or identical to (e.g., a subset of) those in the training input 104 and are used to provide a reference or target for the training of a machine learning model.

Training example modification system 110 can be a software module, a hardware component, or a combination thereof that modifies the training example 102 to create a modified training example 112. This system can replace or augment the identifiers 108 in the training example 102 with positional data, which can be coordinates, vectors, or any suitable format that provides spatial and/or relational information about the items or features identified by identifiers 108.

Modified training example 112 is the result of the processing by the training example modification system 110 and includes a modified training input 114 and a modified target output 118. Training input 114 can retain the original identifiers 108 and/or include set(s) of positional data 116, which provide the positional information replacing or augmenting the identifiers 108. Modified target output 118 includes set(s) of positional data 120, which serve as the new target for the training of the machine learning model, reflecting the positional information of the items or features.

Machine learning model 122 can be any form of computational model capable of learning from data, such as a neural network, for example. This model is trained using the modified training example 112 to learn to predict or respond based on the positional data rather than solely on identifiers.

Model training system 124 can be a software platform, a hardware setup, or a combination thereof that facilitates the training of the machine learning model 122 using the modified training example 112. This system can include computational resources, algorithms, and storage necessary to perform the training process effectively. Model training system 124 can perform supervised training (e.g., supervised finetuning) and/or reinforcement learning (e.g., reinforcement learning from machine feedback) as described elsewhere herein. The training shown in FIG. 1 can be performed as pre-training, training, fine-tuning, and/or post-training.

Each component of the system depicted in FIG. 1 can be implemented in various computing environments, including standalone systems, distributed systems, or cloud-based resources. The examples provided are illustrative and not limiting; other configurations and implementations of each component are possible within the scope of the present disclosure.

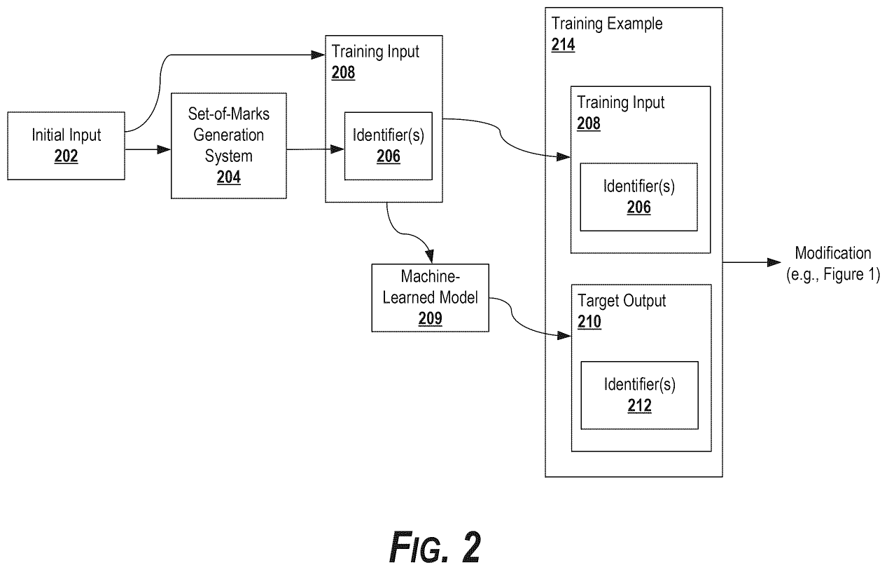

FIG. 2 is a block diagram illustrating a process for generating a set-of-marks-based training dataset and modifying a training example to include positional data for training a machine learning model.

Initial input 202 can be any data source or input data that serves as the basis for generating a training example. This initial input 202 can be an image, text, a combination of various data types, or any other suitable form of data that is to be processed to generate training data for a machine learning model.

Set-of-marks generation system 204 can be a software module, a hardware component, or a combination thereof that processes the initial input 202 to generate a set of identifiers. This system can analyze the initial input 202 and apply various techniques such as pattern recognition, text analysis, image segmentation, and/or DOM parsing to identify and label distinct items or features within the initial input 202.

Training input 208 is the result of the processing by the set-of-marks generation system 204 and includes identifiers 206. These identifiers 206 can be labels, tags, or any form of metadata that correspond to specific items or features identified in the initial input 202 by the set-of-marks generation system 204. Training input 208 can be used as part of a training example for a machine learning model.

Machine-learned model 209 can be any form of computational model capable of processing input data and generating output data. In this context, machine-learned model 209 processes the training input 208 to generate a target output 210. This model can be a pre-trained model.

Training example 214 includes the training input 208 and the target output 210. The target output 210 includes identifiers 212, which can be similar or identical to identifiers 206 and are generated by the machine-learned model 209 as a response or classification based on the training input 208.

The modification process, for example performed as described in FIG. 1, can include modifying the training example 214 to replace or augment identifiers 212 in the target output 210 with positional data. The modified training example can then be used to train a machine learning model to predict or respond based on positional data rather than solely on identifiers, for example as shown in FIG. 1.

Each component of the system depicted in FIG. 2 can be implemented in various computing environments, including standalone systems, distributed systems, or cloud-based resources. The examples provided are illustrative and not limiting; other configurations and implementations of each component are possible within the scope of the present disclosure.

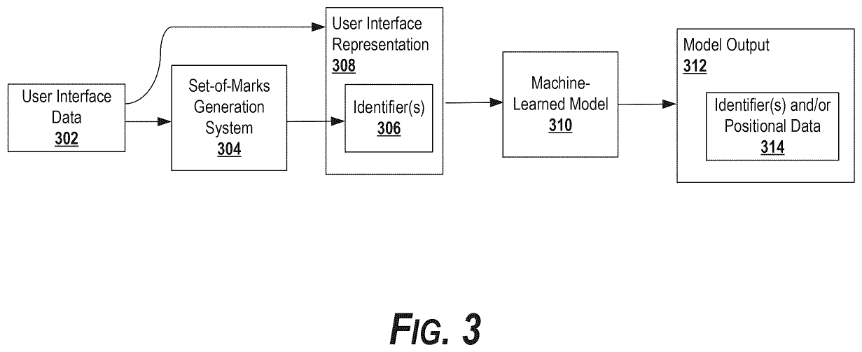

FIG. 3 is a block diagram illustrating an inference-time process for generating a model output from user interface data using a machine-learned model.

User interface data 302 can be any form of data that represents or describes a user interface. This data can include visual elements, structural elements, or any other information that characterizes the user interface. As examples, user interface data 302 can include structured data such as HTML data, DOM data, and/or other information. User interface data 302 can also include visual depictions (e.g., screenshots) of the user interface. User interface data 302 can be sourced from a software application, a web page, or any other system that utilizes a graphical user interface.

Set-of-marks generation system 304 can be a software module, a hardware component, or a combination thereof that processes the user interface data 302 to generate a set of identifiers 306. This system 304 can analyze the user interface data 302 and apply various techniques such as pattern recognition, element detection, DOM scraping, etc. to identify and label distinct interactive or visual elements within the user interface.

User interface representation 308 is the result of the processing by the set-of-marks generation system 304 and includes identifiers 306. These identifiers 306 can be labels, tags, or any form of metadata that correspond to specific elements identified in the user interface data 302. User interface representation 308 can be used as input for a machine learning model to generate outputs based on the identified elements. User interface representation 308 can be the same as user interface data 302 (e.g., with the identifiers 306 added thereto) and/or can include additional or different information. As one example, the user interface data may be a DOM tree for a webpage while the user interface representation 308 may be a visual representation (e.g., screengrab) of the webpage with the identifiers 306 annotated thereto (e.g., as bounding boxes and/or numerals).

Machine-learned model 310 can be any form of computational model capable of processing input data and generating output data. In this context, machine-learned model 310 processes the user interface representation 308 to generate a model output 312. This model can be a neural network,, for example. As one example, the machine-learned model 310 can be the machine learning model 122 after training by the model training system 124, as shown in FIG. 1.

Referring still to FIG. 3, model output 312 includes identifiers and/or positional data 314, which can be generated by the machine-learned model 310 as a response or classification based on the user interface representation 308. Thus, the model 310 can choose whether to output one or more identifiers and/or one or more sets of positional data. Identifiers and/or positional data 314 can include labels, tags, coordinates, vectors, or any other suitable form of data that provides information about the position or identity of elements within the user interface.

Each component of the system depicted in FIG. 3 can be implemented in various computing environments, including standalone systems, distributed systems, or cloud-based resources. The examples provided are illustrative and not limiting; other configurations and implementations of each component are possible within the scope of the present disclosure.

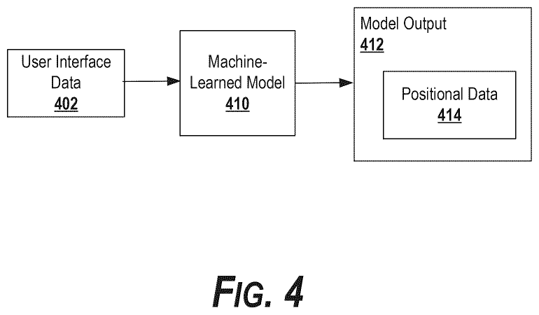

FIG. 4 is a block diagram illustrating a simplified process for generating a model output that includes positional data directly from user interface data using a machine-learned model.

User interface data 402 can be any form of data that represents or describes a user interface. This data can include visual elements, structural elements, or any other information that characterizes the user interface. User interface data 402 can be sourced from a software application, a web page, or any other system that utilizes a graphical user interface. In one example, user interface data 402 may include a visual representation (e.g., screengrab) of the user interface and may be exclusive of (i.e., not include) any identifiers.

Machine-learned model 410 can be any form of computational model capable of processing input data and generating output data. In this context, machine-learned model 410 processes the user interface data 402 to generate a model output 412. As one example, the machine-learned model 410 can be the machine learning model 122 after training by the model training system 124, as shown in FIG. 1.

Referring still to FIG. 4, model output 412 includes positional data 414, which can be generated by the machine-learned model 410 as a response or classification based on the user interface data 402. Positional data 414 can include coordinates, vectors, or any other suitable form of data that provides information about the position of elements within the user interface. Thus, the model 410 can learn to directly output positional data for user interface elements exclusive of identifiers.

Each component of the system depicted in FIG. 4 can be implemented in various computing environments, including standalone systems, distributed systems, or cloud-based resources. The examples provided are illustrative and not limiting; other configurations and implementations of each component are possible within the scope of the present disclosure.

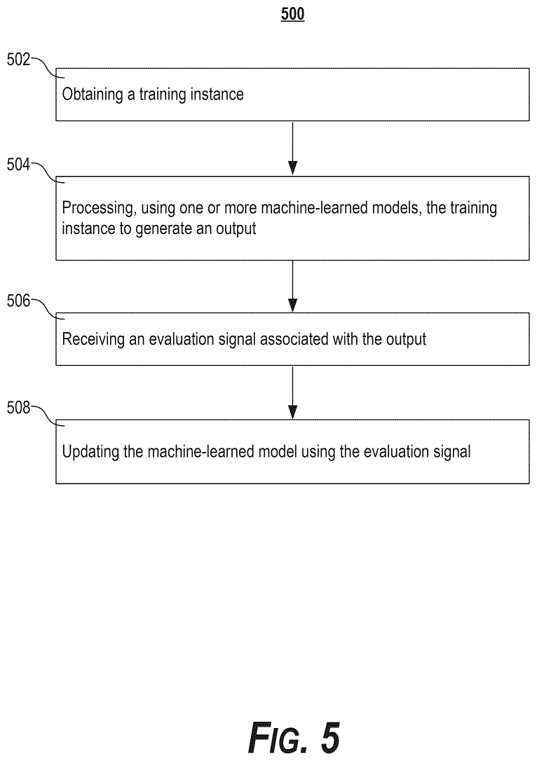

FIG. 5 depicts a flowchart of a method 500 for training one or more machine-learned models according to aspects of the present disclosure.

One or more portion(s) of example method 500 can be implemented by a computing system that includes one or more computing devices such as, for example, computing systems described with reference to the other figures. Each respective portion of example method 500 can be performed by any (or any combination) of one or more computing devices. Moreover, one or more portion(s) of example method 500 can be implemented on the hardware components of the device(s) described herein, for example, to train one or more systems or models. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 500 can be performed additionally, or alternatively, by other systems.

At 502, example method 500 can include obtaining a training instance. A set of training data can include a plurality of training instances divided between multiple datasets (e.g., a training dataset, a validation dataset, or testing dataset). A training instance can be labeled or unlabeled. Although referred to in example method 500 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 504, example method 500 can include processing, using one or more machine-learned models, the training instance to generate an output. The output can be directly obtained from the one or more machine-learned models or can be a downstream result of a chain of processing operations that includes an output of the one or more machine-learned models.

At 506, example method 500 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 508, example method 500 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 500 can include implementing a number of generalization techniques (e.g., weight decays, dropouts, etc.) to improve the generalization capability of the models being trained.

In some implementations, example method 500 can be implemented for training a machine-learned model from an initialized state to a fully trained state (e.g., when the model exhibits a desired performance profile, such as based on accuracy, precision, recall, etc.).

In some implementations, example method 500 can be implemented for particular stages of a training procedure. For instance, in some implementations, example method 500 can be implemented for pre-training a machine-learned model. Pre-training can include, for instance, large-scale training over potentially noisy data to achieve a broad base of performance levels across a variety of tasks/data types.

In some implementations, example method 500 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 500 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 500 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

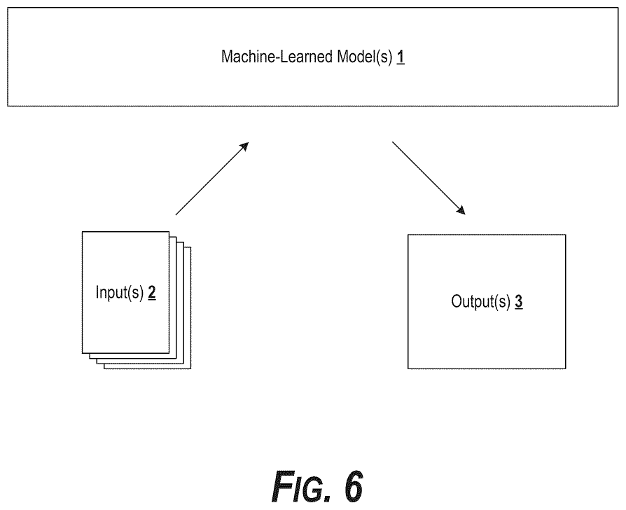

FIG. 6 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. Although various features, variations, and implementations described below are described with respect to machine-learned model(s) 1, it is to be understood that such features, variations, and implementations are to be understood as described with respect to any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

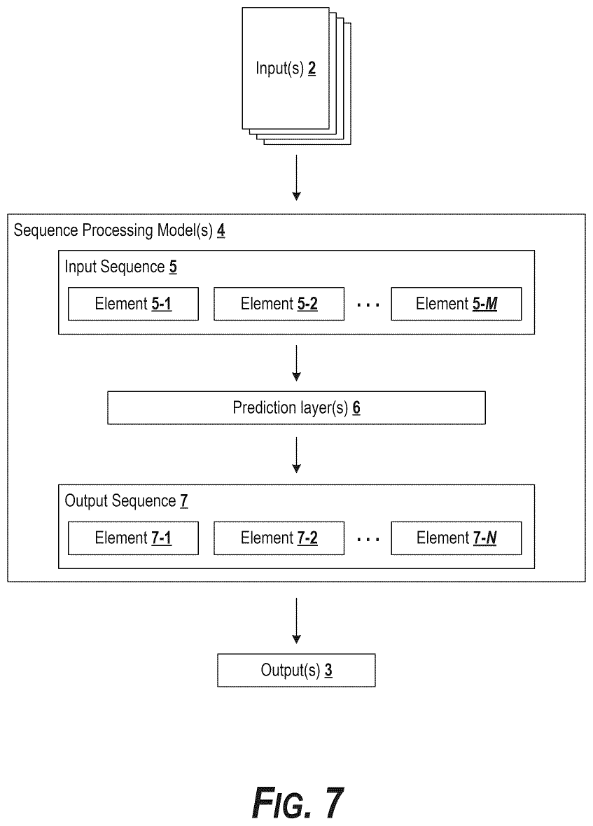

FIG. 7 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Example multimodal models include Gemini 1.5 (see, e.g., Gemini Team Google, et al., Gemini 1.5: Unlocking multimodal understanding across millions of tokens of context, arXiv:2403.05530 (2024)) and PaliGemma2 (see, e.g., Steiner, et al., PaliGemma 2: A Family of Versatile VLMs for Transfer, arXiv:2412.03555v1 (Dec. 4, 2024)).

Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . 5-M can represent tokens obtained using a tokenizer. For instance, a tokenizer can process a given portion of an input source and output a series of tokens (e.g., corresponding to input elements 5-1, 5-2, . . . 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . 5-M depicted in FIG. 7 can be the tokens or can be the embedded representations thereof.

Prediction layer(s) 6 can predict one or more output elements 7-1, 7-2, . . . 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

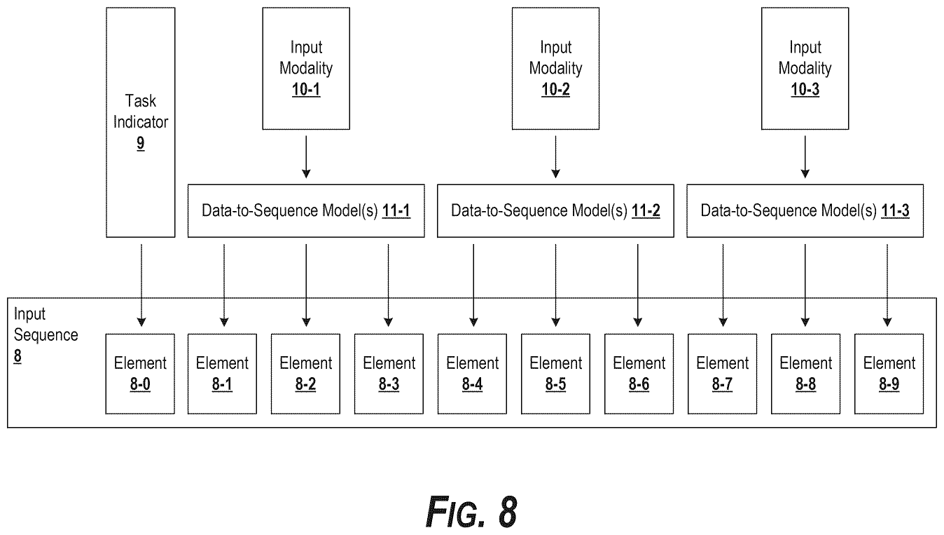

FIG. 8 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

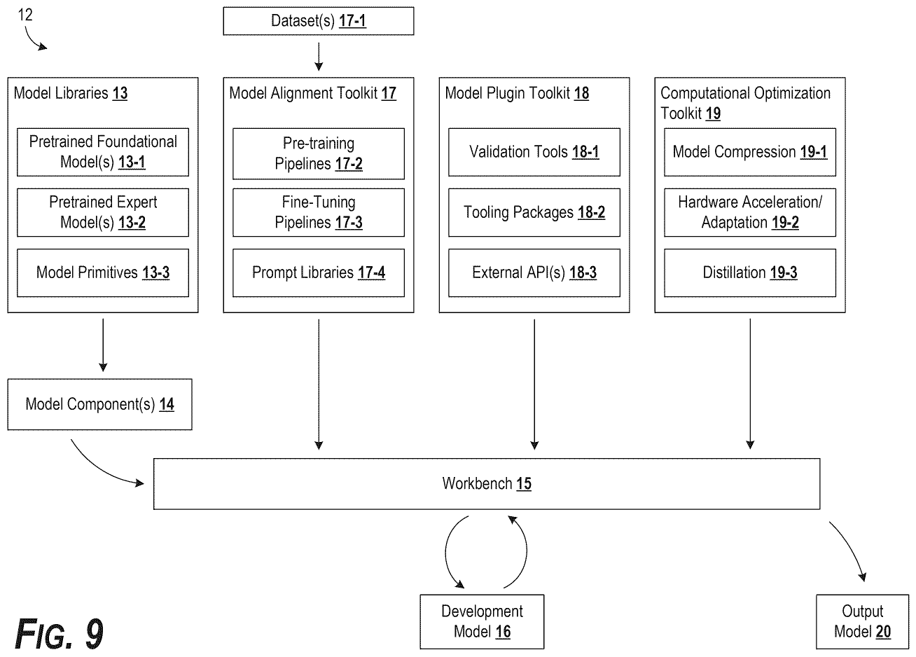

FIG. 9 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

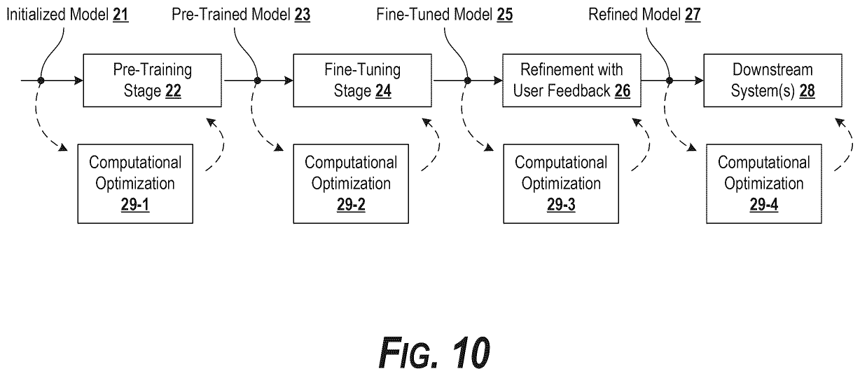

FIG. 10 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . 29-4 can all be the same, all be different, or include at least some different optimization techniques.

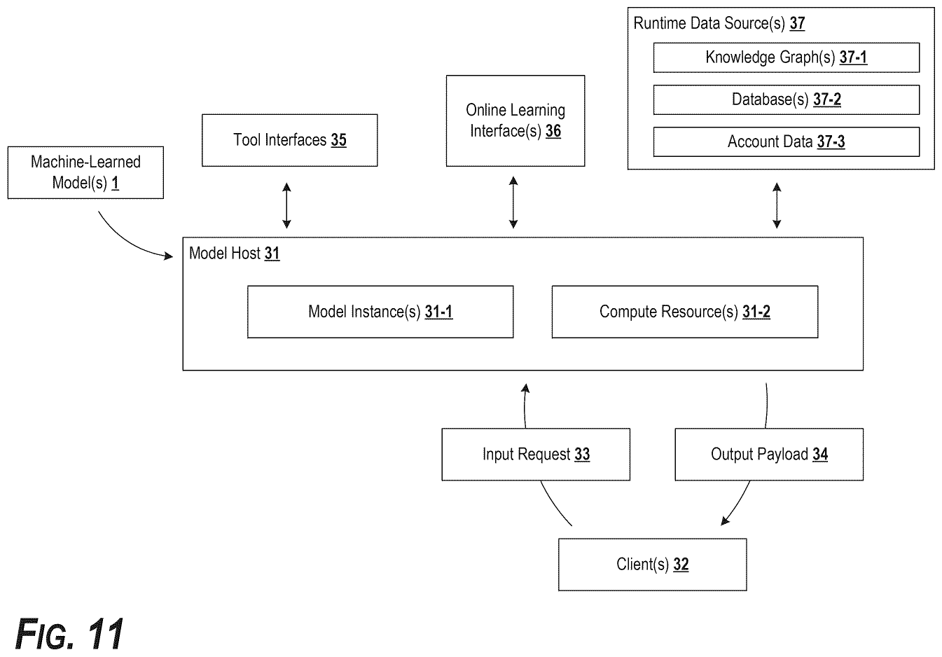

FIG. 11 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

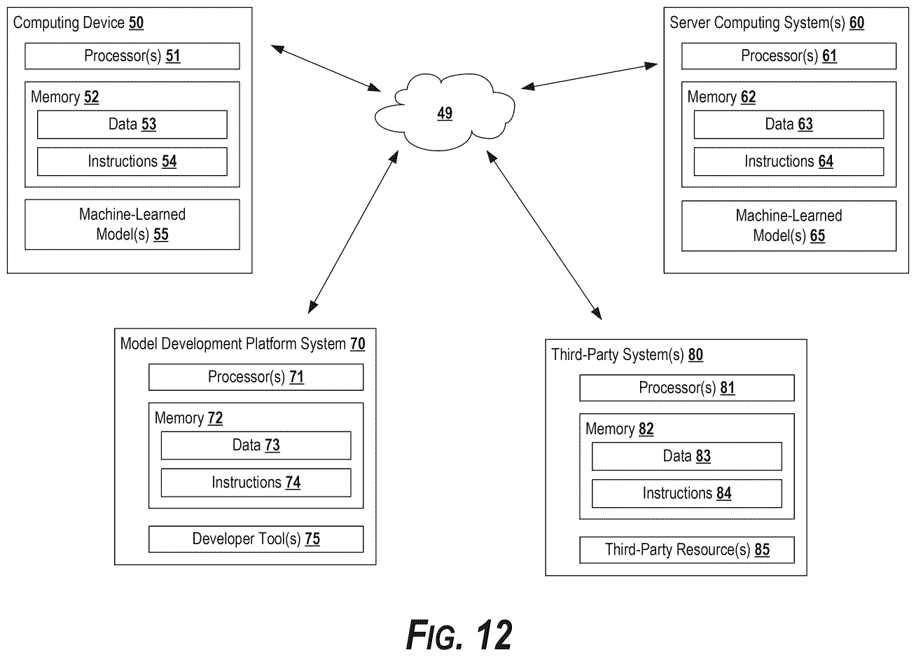

FIG. 12 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 12 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

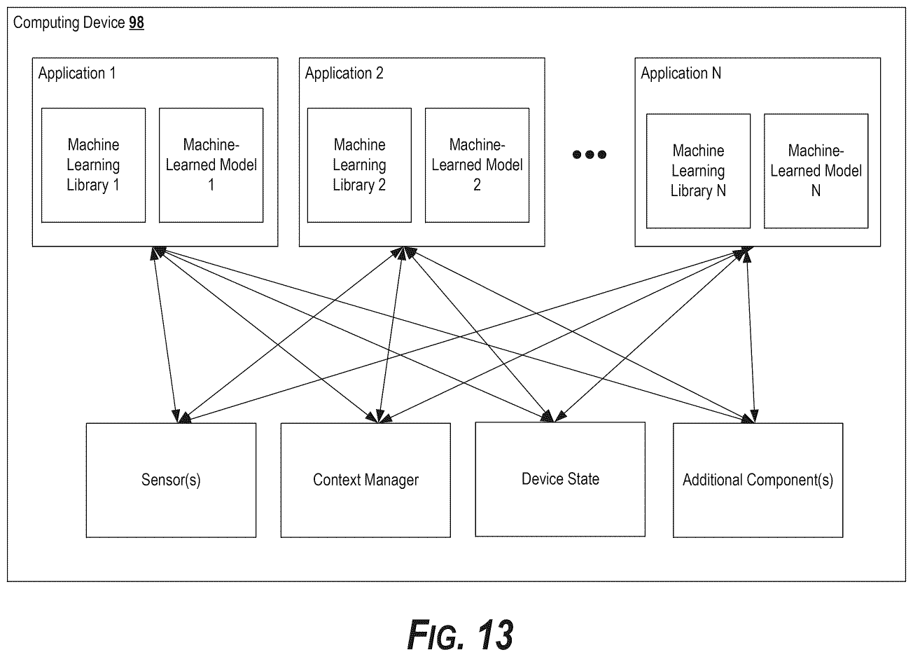

FIG. 13 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 13, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

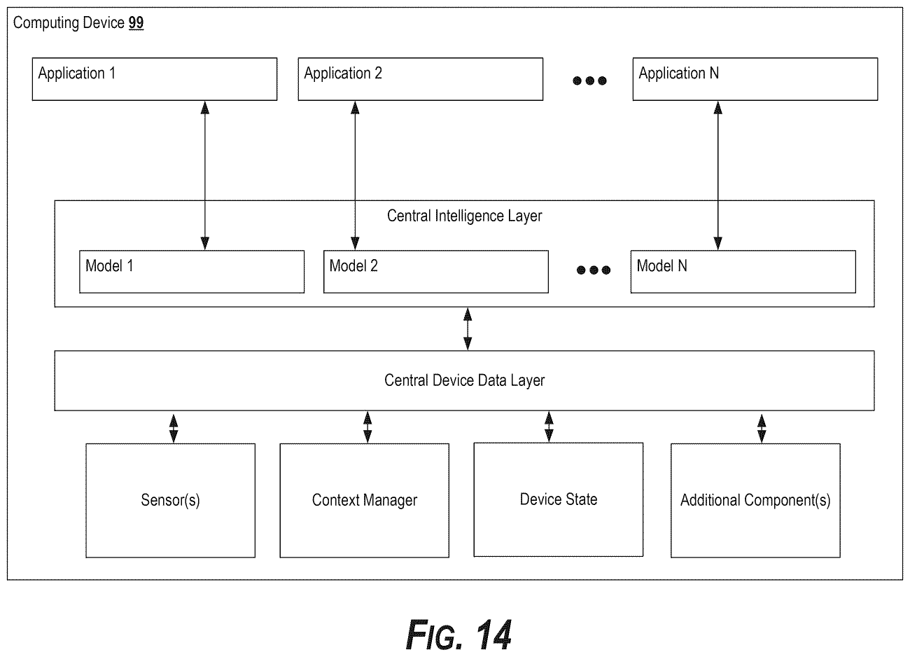

FIG. 14 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 14, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 14, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, the method comprising:
obtaining, by a computing system comprising one or more computing devices, a training example comprising a training input and a target output,
wherein the training input comprises a plurality of identifiers that respectively correspond to a plurality of items; and
wherein the target output comprises one or more of the plurality of identifiers;
modifying, by the computing system, the training example to obtain a modified training example,
wherein modifying the training example comprises respectively replacing, in at least the target output, the one or more of the plurality of identifiers contained in the target output with one or more sets of positional data that respectively provide positional information for the one or more items to which the one or more of the plurality of identifiers contained in the target output correspond; and
training, by the computing system, a machine learning model on the modified training example.

2. The computer-implemented method of claim 1, wherein obtaining the training example comprises:
processing an initial input to generate the plurality of identifiers; and
annotating the initial input with the plurality of identifiers to generate the training input.

3. The computer-implemented method of claim 1, wherein the plurality of items comprise a plurality of user interface elements contained in a user interface.

4. The computer-implemented method of claim 3, wherein the target output comprises an action output that selects for interaction one or more of the user interface elements.

5. The computer-implemented method of claim 3, wherein the plurality of identifiers were generated by parsing a document object model (DOM) tree for the user interface.

6. The computer-implemented method of claim 1, wherein the training input comprises textual content, and wherein the plurality of identifiers are embedded within the textual content.

7. The computer-implemented method of claim 1, wherein the training input comprises image content, and wherein the plurality of identifiers are embedded within the image content.

8. The computer-implemented method of claim 1, wherein modifying the training example comprises respectively replacing, in both the training input and the target output, the plurality of identifiers with a plurality of sets of positional data that respectively provide positional information for the plurality of items to which the plurality of identifiers correspond.

9. The computer-implemented method of claim 1, wherein modifying the training example comprises respectively removing, from the training input, the one or more of the plurality of identifiers that are contained in the target output.

10. The computer-implemented method of claim 1, wherein modifying the training example comprises respectively removing, from the training input, only the one or more of the plurality of identifiers that are contained in the target output while leaving the other identifiers within the training input.

11. The computer-implemented method of claim 1, wherein modifying the training example comprises respectively removing, from the training input, all of the plurality of identifiers.

12. The computer-implemented method of claim 1, wherein the one or more sets of positional data comprise one or more sets of two-dimensional coordinates.

13. The computer-implemented method of claim 1, wherein training the machine learning model on the modified training example comprises performing supervised finetuning with the machine learning model on the modified training example.

14. The computer-implemented method of claim 1, wherein training the
machine learning model on the modified training example comprises performing reinforcement learning with the machine learning model on the modified training example, and wherein performing reinforcement learning with the machine learning model on the modified training example comprises:
processing the training input of the modified training example with the machine learning model to generate, as an output of the machine learning model, a predicted output;
generating a reward value based on the predicted output; and
modifying one or more values of one or more parameters of the machine learning model based on the reward value.

15. The computer-implemented method of claim 1, wherein training the
machine learning model on the modified training example comprises:
determining that the one or more items to which the one or more of the plurality of identifiers contained in the target output correspond were not correctly parsed into the training input; and
in response to determining that the one or more items to which the one or more of the plurality of identifiers contained in the target output correspond were not correctly parsed into the training input, training the machine learning model on the modified training example.

16. The computer-implemented method of claim 1, further comprising, prior
to training, by the computing system, the machine learning model on the modified training example:
training, by the computing system, the machine learning model on a set of training data comprising training inputs and training outputs that contain positional data for items exclusive of item identifiers.

17. A computer-implemented method, the method comprising:
generating, by a computing system comprising one or more computing devices, a set-of-marks-based training dataset, wherein generating the set-of-marks-based training dataset comprises, for each of a number of training inputs:
generating a plurality of identifiers respectively for a plurality of items included in the training input;
annotating the training input to include the plurality of identifiers;
processing the annotated training input with a machine-learned model to generate, as an output of the machine-learned model a model-generated output, wherein the model-generated output comprises one or more of the plurality of identifiers; and
storing the model-generated output as a target output for the training input to generate a training example;
modifying, by the computing system, the training example to obtain a modified training example,
wherein modifying the training example comprises respectively replacing, in at least the target output, the one or more of the plurality of identifiers contained in the target output with one or more sets of positional data that respectively provide positional information for the one or more items to which the one or more of the plurality of identifiers contained in the target output correspond; and
training, by the computing system, a machine learning model on the modified training example.

18. The computer-implemented method of claim 17, wherein the machine learning model is the same as the machine-learned model.

19. The computer-implemented method of claim 17, further comprising, prior
to training, by the computing system, the machine learning model on the modified training example:
training, by the computing system, the machine learning model on a set of training data comprising training inputs and training outputs that contain positional data for items exclusive of item identifiers.

20. A computing system, comprising:
one or more processors; and
one or more non-transitory computer-readable media that collectively store instructions that, when executed by the one or more processors, cause the computing system to perform operations, the operations comprising:
obtaining, by the computing system, user interface data descriptive of a user interface;
processing, by the computing system, the user interface data to generate a plurality of identifiers respectively for a plurality of items contained in the user interface;
generating, by the computing system, a model input containing a representation of the user interface that has been annotated with the plurality of identifiers; and
processing, by the computing system, the model input with a machine-learned model to generate a model output,
wherein the model output comprises one of the plurality of identifiers or a predicted set of coordinates.
